(19) United States
(12) Patent Application Publication
(10) Pub. No.: US 2011/0241502 A1
(43) Pub. Date: Oct. 6, 2011

(54) CORNER JOINT COUPLING STRUCTURE OF ALUMINUM EXTRUSION CABINET

(76) Inventor: PAO-YI KAO, Kaohsiung Hsien (TW)

(21) Appl. No.: 12/753,108

(22) Filed: Apr. 2, 2010

(51) Int. Cl. F16B 12/30

(52) U.S. Cl. 312/111

(57) ABSTRACT

A corner joint coupling structure of aluminum extrusion cabinet includes a corner joint, a lengthwise horizontal bar, a widthwise horizontal bar, and a vertical bar. The corner joint forms tenon portions for coupling the lengthwise horizontal bar, the widthwise horizontal bar, and the vertical bar. The lengthwise horizontal bar forms therein an inner-threaded channel and the corner joint forms a through hole corresponding to the inner-threaded channel. A threaded fastening element is receivable through the through hole and is threadingly engageable with the inner-threaded channel. As such, assembling operation of two lateral side panel assemblies of the cabinet is made easy and effortless to allow general consumers to do the assembling by themselves in a noise-free manner.

### (a) TECHNICAL FIELD OF THE INVENTION

The present invention generally relates to a corner joint coupling structure of aluminum extrusion cabinet, and more particularly to a corner joint coupling structure that allows for coupling with a side panel assembly through holes defined in the corner joint to receive a threaded fastening element that engages and is secured to the corner joint.

### (b) DESCRIPTION OF THE PRIOR ART

With the development of industrial techniques, furniture made with aluminum extrusion processes is commonly used and gradually takes the place of traditional wooden or steel furniture. This is at least partly because the availability of material and efficiency of manufacturing of the aluminum extrusion furniture are far better than those of the traditional wooden furniture, and in addition the aluminum extrusion furniture is durable, light-weighted, and easy to transport and has no such drawbacks of being eaten by for example insects or corrosion found in wooden or steel furniture. Further, the aluminum extrusion furniture shows good sense of quality. For these reasons, aluminum extrusion furniture is quite prevailing in the furniture market.

Taking an aluminum extrusion cabinet, which is commonly available in the market, as an example, due to the modern trend of do-it-yourselves, aluminum extrusion cabinets that are available in the market are often of designs that allow the general consumers to purchase a package of components to do assembling by themselves at homes. A general structure of such a market available aluminum extrusion cabinets is formed by assembling a plurality of corner joints 10, horizontal bars 20, vertical bars 30, and shelf boards 40 together (as shown in FIG. 1), wherein each corner joint 10 forms, at locations thereof corresponding to associated horizontal bars 20 and vertical bars 30, tenon portions 101 (see FIG. 2), which are respectively insertable into hollow portions of the horizontal bars 20 and the vertical bars 30 to complete the assembling, which is quite a simple operation.

The construction described is that of the conventional aluminum extrusion cabinets. To ensure fitting tightness of the assembled cabinet, the tenon portions 101 of the corner joints 10 must be securely fit into the hollow portions of the horizontal bars 20 and the vertical bars 30 when the corner joints 10 and the horizontal and vertical bars 20, 30 are assembled. Often, such an operation is done by using a regular hammer (or rubber hammer) to hit these components for fitting and assembling. The hitting of the hammer on the aluminum extrusion components results in great sounds, which cause noise pollution and affect the silence and calm of the neighborhood. Further, the components so fit together may get loosened and thus separated with lapse of time of use. Further, such a force fitting operation may prevent consumers with weak strength from securely assembling the components together, leading to insufficient of structural strength of the assembled cabinet. Apparently, further improvements are desired in these respects.

### SUMMARY OF THE INVENTION

In view of the above discussed problems, the present invention aims to overcome the problems of the conventional products by showing features that allow a user to enjoy the pleasure of DIY assembling and also ensures ease of assembling. Based on such a consideration, researches and studies have been extensively conducted and a breakthrough in these respects is finally realized by the completion of the present invention. The essential idea found in the present invention is that components of a cabinet that are hard to securely assemble together by the general consumers are pre-assembled in the workshop before shipping. In other words, according to the present invention, opposite side panel assemblies of an aluminum extrusion cabinet that is formed by properly assembling corner joints, widthwise horizontal bars, and vertical bars, are assembled in advance in the workshop. This eliminates the problem of noise generated by the consumers' assembling the components but still allows the consumers to do assembling of the remaining parts by themselves, and the amount of space required for shipping and storage is reduced. Consequently, a win-win strategy is realized.

Thus, the present invention provides a corner joint coupling structure of aluminum extrusion cabinet, comprising a corner joint, a lengthwise horizontal bar, a widthwise horizontal bar, and at least one vertical bar. The corner joint forms coupling tenon portions corresponding to the lengthwise horizontal bar, the widthwise horizontal bar, and the vertical bar. The corner joint, the widthwise horizontal bar, and the vertical bar are assembled together through force fitting of the tenon portions to form a side panel assembly for each of two lateral sides of the cabinet. The lengthwise horizontal bar forms therein at least one inner-threaded channel. The corner joint forms a through hole corresponding to the inner-threaded channel for receiving a threaded fastening element that is fit through the through hole and threadingly engages the inner-threaded channel to assemble the side panel assembly to the cabinet.

Further, the tenon portion that couples the vertical bar forms a plurality of the outward projecting ribs. Further, the lengthwise horizontal bar and the width horizontal bar have inside faces respectively forming a first slot and a second slot corresponding to each other. The first and second slots are provided to receive and couple a horizontal shelf board. Further, the widthwise horizontal bar has a side face forming a third slot and the vertical bar has a side face forming a fourth slot. The third slot corresponds to the fourth slot. The third and fourth slots are provided to receive and couple a widthwise vertical board. Further, the lengthwise horizontal bar has a side face forming a fifth slot and the vertical bar has a side face forming a sixth slot. The fifth slot corresponds to the sixth slot. The fifth and sixth slots are provided to receive and couple a lengthwise vertical board.

It is appreciated that the present invention aims to provide a corner joint coupling structure of an aluminum extrusion cabinet that ensures both easiness of DIY assembling and structural strength of the assembled cabinet and this is realized by pre-assembling a corner joint, a widthwise horizontal bar, and a vertical bar in a workshop to form a side panel assembly for each of two lateral sides of the cabinet and such partially pre-assembled components are then packaged and shipped to the general consumers to allow the consumers to only assemble the two side panel assemblies by inserting and engaging a threaded fastening element with an inner-threaded channel to couple the corner joint and the lengthwise horizontal bar together. As such, the two side panel assemblies can be assembled in an easy and effortless manner and the assembling operation can be done at homes in a noise free manner, but still offering the pleasure of DIY assembling to the general consumers.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a conventional aluminum extrusion cabinet.

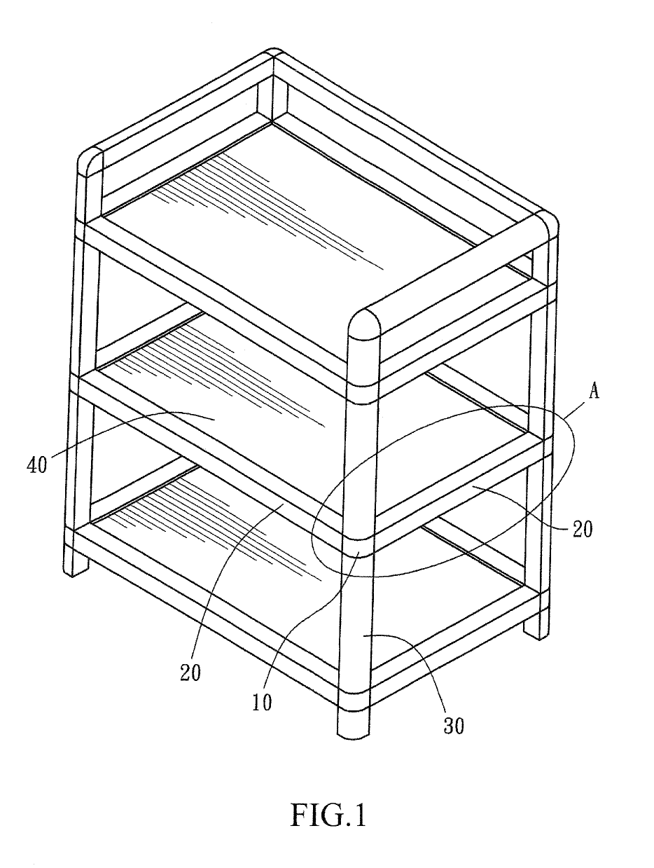

FIG. 2 is an exploded view of the circled portion A of FIG. 1.

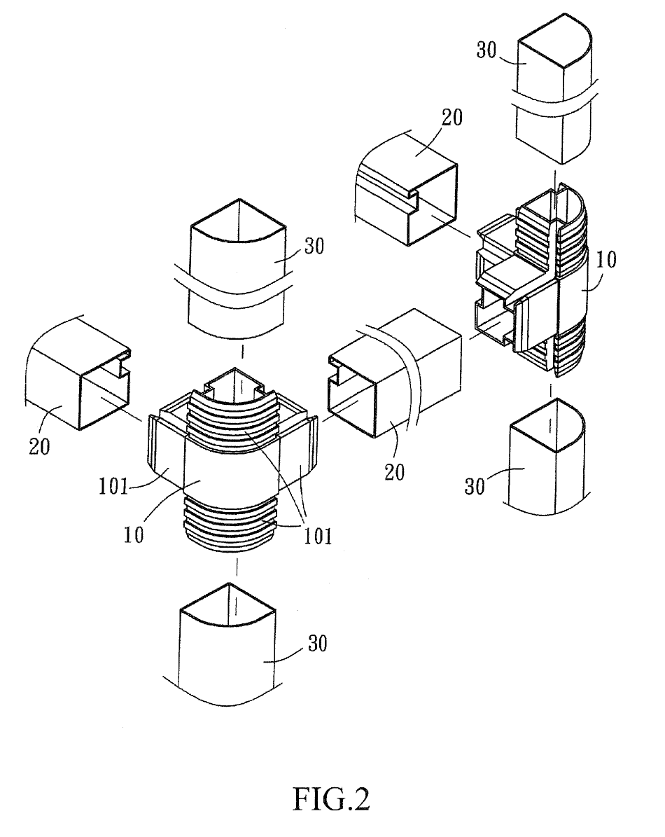

FIG. 3 is a perspective view showing an aluminum extrusion cabinet according to the present invention.

FIG. 4 is an exploded view of the circled portion A′ of FIG. 3.

FIG. 5 is a plan view showing the structural arrangement of the aluminum extrusion cabinet according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

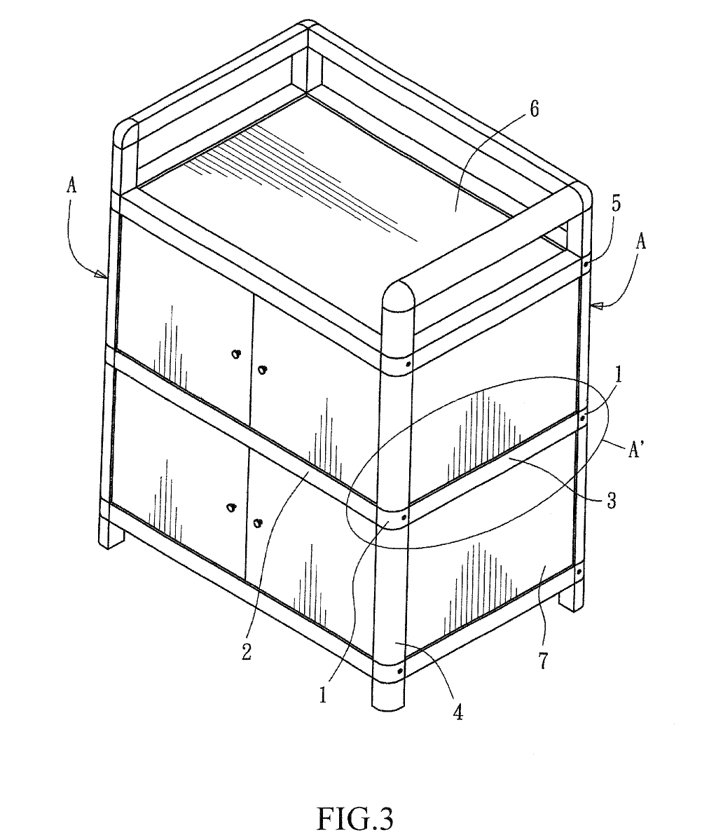

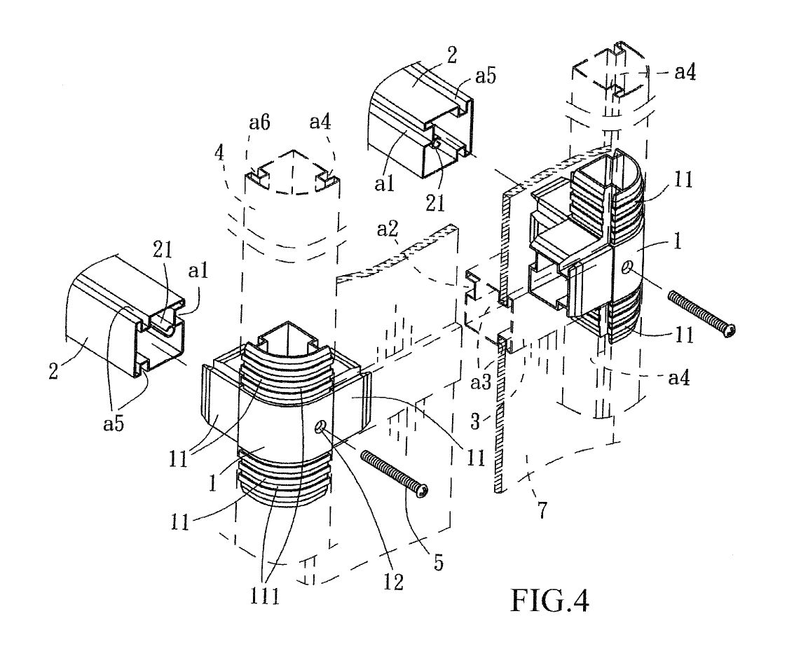

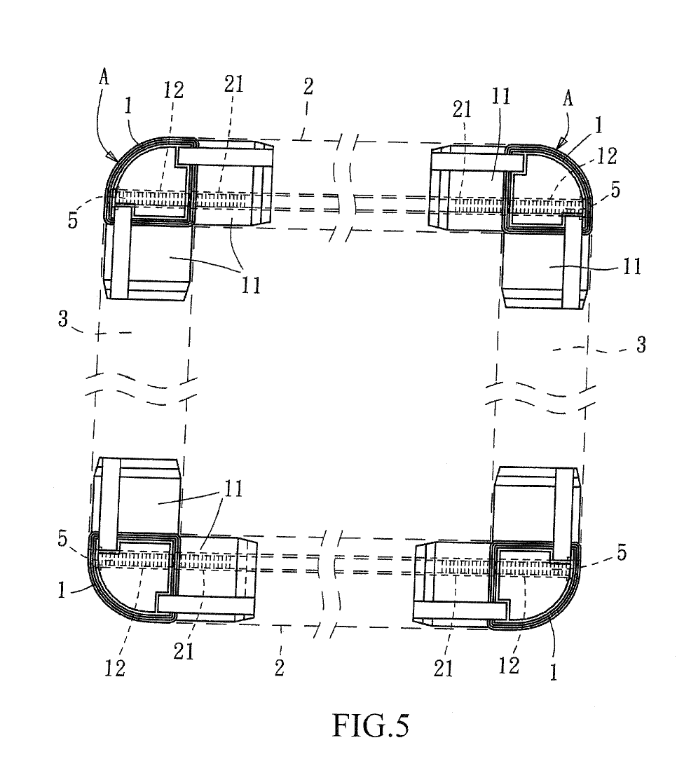

As shown in FIG. 3, the present invention provides a corner joint coupling structure of aluminum extrusion cabinet, which comprises a corner joint 1, a lengthwise horizontal bar 2, a widthwise horizontal bar 3, and at least one vertical bar 4, wherein the corner joint 1 forms, at locations corresponding to the lengthwise horizontal bar 2, the widthwise horizontal bar 3, and the vertical bar 4, tenon portions 11 (see FIG. 4) for coupling purposes. In the following description, an example that includes two vertical bars 4 will be given and the two vertical bars are respectively set on and under the corner joint 1. The tenon portions 11 that couple the vertical bar 4s are each provided with a plurality of outward projecting ribs 111. As such, the corner joint 1 and the widthwise horizontal bar 3 and the vertical bars 4 are respectively coupled together through force fitting of the tenon portions 11 in a workshop to form a side panel assembly A (see FIGS. 3 and 5) for each of two lateral sides of the cabinet.

Next, the lengthwise horizontal bar 2 forms therein at least one inner-threaded channel 21 (one inner-threaded channel being visible in the drawing as an example for explanation). The corner joint 1 forms a through hole 12 corresponding to the inner-threaded channel 21 and a threaded fastening element 5 (such as bolt) is received through the through hole 12 to engage the inner-threaded channel 21 to assemble the side panel assembly A to the lateral side of the cabinet (as illustrated in FIG. 5).

Further, the lengthwise horizontal bar 2 and the widthwise horizontal bar 3 have inside faces that respectively forms a first slot a1 and a second slot a2 corresponding to each other (as shown in FIG. 4). The first and second slots a1, a2 are provided for receiving and coupling a horizontal shelf board 6 (the horizontal shelf board being visible in FIG. 3). Next, the widthwise horizontal bar 3 side faces each forming a third slot a3 and each vertical bar 4 has a side face forming a fourth slot a4, such that the third slot a3 corresponds to the fourth slot a4 for receiving and coupling a widthwise vertical board 7 (see FIG. 4). Further, the lengthwise horizontal bar 2 has side faces each forming a fifth slot a5 and each vertical bar 4 has a side face forming a sixth slot a6, such that the fifth slot a5 corresponds to the sixth slot a6 for receiving and coupling a lengthwise side board (see FIG. 4, but the lengthwise vertical board being omitted in the drawing).

With such a construction, since the corner joint 1, the widthwise horizontal bar 3, and the vertical bar 4 that require force fitting therebetween are pre-assembled together in the workshop to form the side panel assemblies A for the two lateral sides of the cabinet, or the widthwise side board 7, if any, is also pre-assembled in the workshop, the consumers only need to fit the horizontal shelf board 6 (and the lengthwise vertical board) into the corresponding slots and then set threaded fastening element 5 between the two side panel assemblies A and the lengthwise horizontal bar 2 by inserting the threaded fastening element 5 through the through hole 12 to engage the inner-threaded channel 21, by which the assembling operation is completed. In this way, the degree of difficult for the assembling operation is significantly reduced, and the goal of noise free home assembling is met, and the consumers are still allowed to enjoy the pleasure of DIY assembling with guaranteed fitting tightness and improved product life span. On the other hand, the manufacturers still have the advantages of reduced amount of space for shipping and storage. As such, the drawbacks of the conventional designs and structures are overcome. Further, the above discussed cabinet components allow for mass production and can be assembled in diverse was for forming various configuration for applications in shelves, glass cabinets, and display cabinets.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A corner joint coupling structure of aluminum extrusion cabinet, comprising a corner joint, a lengthwise horizontal bar, a widthwise horizontal bar, and at least one vertical bar, the corner joint forming coupling tenon portions corresponding to the lengthwise horizontal bar, the widthwise horizontal bar, and the vertical bar, characterized in that the lengthwise horizontal bar forms therein at least one inner-threaded channel and the corner joint forms a through hole corresponding to each inner-threaded channel for receiving a threaded fastening element through the through hole and threadingly engaging the inner-threaded channel.

2. The corner joint coupling structure according to claim 1, wherein the tenon portion that couples the vertical bar forms a plurality of the outward projecting ribs.

3. The corner joint coupling structure according to claim 1, wherein the lengthwise horizontal bar and the widthwise horizontal bar have inside faces that respectively form a first slot and a second slot corresponding to each other, the first and second slots receiving and coupling a horizontal shelf board.

4. The corner joint coupling structure according to claim 3, wherein the widthwise horizontal bar has a side face forming a third slot and the vertical bar has a side face forming a fourth slot, the third slot corresponding to the fourth slot, the third and fourth slots receiving and coupling a widthwise vertical board.

5. The corner joint coupling structure according to claim 4, wherein the lengthwise horizontal bar has a side face forming a fifth slot and the vertical bar has a side face forming a sixth slot, the fifth slot corresponding to the sixth slot, the fifth and sixth slots receiving and coupling a lengthwise vertical board.
